(19) United States
(12) Patent Application Publication
(10) Pub. No.: US 2019/0377175 A1
(43) Pub. Date: Dec. 12, 2019

(54) APPARATUS AND METHOD THAT MITIGATE SURFACE OCCLUSION

(71) Applicant: GM GLOBAL TECHNOLOGY OPERATIONS LLC, DETROIT, MI (US)

(72) Inventors: Taeyoung Han, BLOOMFIELD HILLS (US); Bahram Khalighi, BIRMINGHAM (US)

(21) Appl. No.: 16/001,220

(22) Filed: Jun. 6, 2018

(51) Int. Cl. G02B 27/00; G01K 13/00; G01S 7/497; H05B 3/84; H05B 1/02

(52) U.S. Cl. CPC G02B 27/0006; G01K 13/00; G01S 7/497; G01S 17/936; H05B 1/0288; G01S 2007/4977; H05B 3/84

(57) ABSTRACT

An apparatus configured to mitigate surface occlusion is provided. The apparatus includes a surface, an occlusion mitigating element integrated with the surface; and a controller configured to determine at least one of a fog condition or an ice condition based on an offset temperature, and control the occlusion mitigating element according to the determined at least one of the fog condition and the ice condition, a surface temperature of the surface, a dew point temperature, and the offset temperature.

### INTRODUCTION

Apparatuses and methods consistent with exemplary embodiments relate to de-fogging and de-icing surfaces. More particularly, apparatuses and methods consistent with exemplary embodiments relate to automatically de-fogging and de-icing surfaces.

### SUMMARY

One or more exemplary embodiments provide an apparatus that clears an occluded surface or mitigates surface or lens occlusion. More particularly, one or more exemplary embodiments provide detects whether lens or surface is likely to be occluded by frost or fog, and controls a defogging or de-icing element to de-fog or de-ice the surface or lens according to the likelihood or risk that the lens or surface is occluded by ice or fog.

According to an aspect of an exemplary embodiment, an apparatus that mitigates surface occlusion is provided. The apparatus includes a surface, an occlusion mitigating element integrated with the surface, and a controller configured to determine at least one of a fog condition or an ice condition based on an offset temperature from a surface temperature, and control the occlusion mitigating element according to the determined at least one of the fog condition and the ice condition, the surface temperature of the surface, a dew point temperature, and the offset temperature.

The controller may be configured to determine the dew point temperature from a lookup table based on a reference temperature detected by a temperature sensor and a humidity detected by a humidity sensor.

The controller may be configured to set the offset temperature according to a control setpoint corresponding to an accuracy of a temperature sensor measuring the surface temperature and a speed of a power supply.

The controller may be configured to determine the fog condition if the offset temperature is greater than zero.

The controller may be configured to determine the ice condition if the offset temperature is less than zero.

The controller may be configured to power off the occlusion mitigating element if the dew point temperature is less than the offset temperature.

The controller may be configured to power on the occlusion mitigating element to a full power state if the surface temperature is less than the dew point temperature.

The controller may be configured to power on the occlusion mitigating element to a power level proportional to the determined at least one of the fog condition and the ice condition if the surface temperature is greater than the dew point temperature and the dew point temperature is greater than the offset temperature.

The controller may be configured to control to output a pulse width modulated signal according to the power level.

The surface may be the lens of a sensor. The sensor may be at least one from among a lidar and a camera.

The occlusion mitigating element may be a heating film disposed on the lens.

The apparatus may include a power supply and a power switch configured to supply power to the occlusion mitigating element.

The controller may be configured to control the power supplied from the power supply to the occlusion mitigating element based on the determined at least one of the fog condition and the ice condition, the lens temperature, the dew point temperature, and the offset temperature.

The occlusion mitigating element may be a de-icing film and a defogging film with a polyvinyl butyral (PVB) layer disposed between the de-icing film and the defogging film, and the occlusion mitigating element may be disposed on the lens between glass layers of the lens.

The occlusion mitigating element may include a buss bar, wherein the controller is configured to supply power to the buss bar to mitigate the surface occlusion based on the determined at least one of the fog condition and the ice condition, the surface temperature, the dew point temperature, and the offset temperature.

According to an aspect of an exemplary embodiment, a method of mitigating surface occlusion is provided. The method determining at least one of a fog condition or an ice condition based on an offset temperature from a surface temperature, and in response to determining the at least one the fog condition or the ice condition is in effect, controlling an occlusion mitigating element according to the determined at least one of the fog condition and the ice condition, the surface temperature of the surface, a dew point temperature, and the offset temperature.

The offset temperature may be determined based on a sensor accuracy of a sensor measuring the surface temperature and responsiveness of a power supply.

The controlling the occlusion mitigating element may include controlling to power on the occlusion mitigating element to a full power state if the surface temperature is less than the dew point temperature and controlling to power off the occlusion mitigating element if the dew point temperature is less than the offset temperature.

The controlling the occlusion mitigating element may include controlling to power on the occlusion mitigating element to a power level proportional to the determined at least one of the fog condition and the ice condition if the surface temperature is greater than the dew point temperature and the dew point temperature is greater than the offset temperature.

Other objects, advantages and novel features of the exemplary embodiments will become more apparent from the following detailed description of exemplary embodiments and the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 shows a block diagram of an apparatus that mitigates surface occlusion according to an exemplary embodiment;

FIG. 2 shows a flow diagram of a method that mitigates surface occlusion according to an exemplary embodiment;

FIGS. 3A and 3B show a flow diagram of a method that determines fog potential and setting the power and mode of a de-fogging device according to an aspect of an exemplary embodiment;

FIGS. 4A and 4B show a flow diagram of a method that determines frost and ice potential and setting power and mode of a de-icing device according to an aspect of an exemplary embodiment; and

FIGS. 5A-5C show illustrations of various aspects of an apparatus that mitigates surface occlusion according to several aspects of exemplary embodiments.

### DETAILED DESCRIPTION

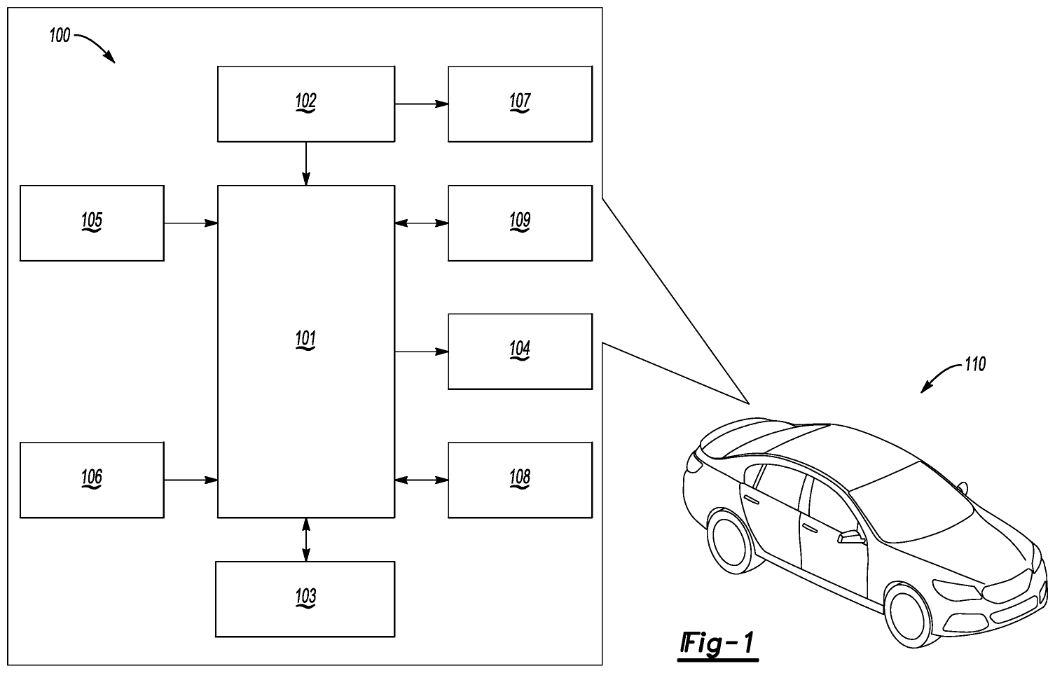

An apparatus configured to mitigate surface occlusion will now be described in detail with reference to FIGS. 1-5C of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Automated or autonomous control systems are being developed and equipped on vehicles. These systems are designed to take over aspects of controlling a vehicle from a human driver. For example, automated or autonomous control systems may control steering, braking, windshield wipers, HVAC systems, charging systems, etc. When a vehicle is operating in automated or autonomous control mode, the vehicle relies on information from sensors to perceive its environment. For example, a camera, a radar, an ultrasonic sensor, and a lidar are all examples of sensors that provide information on an environment to automated or autonomous control systems. Due to the outdoor environment and various weather and environmental conditions external vehicle sensors are now exposed to, the sensors, their lenses or surfaces may be become occluded due to fog, frost, debris and/or other environmental conditions. Thus, sensors may be equipped with cleaning devices that aid in keeping the sensor or a lens of the sensor clean when surfaces or lenses become. However, an autonomous vehicle needs to be able to perceive the environment, detect sensor occlusion and environmental conditions that lead to sensor occlusion and address the sensor occlusion with little to no operator intervention.

FIG. 1 shows a block diagram of an apparatus that mitigates surface occlusion according to an exemplary embodiment. As shown in FIG. 1, the apparatus configured to mitigate surface occlusion 100, according to an exemplary embodiment, includes a controller 101, a power supply 102, a storage 103, an output 104, a sensor 105, a user input 106, a communication device 108 and an occlusion mitigating element 109. However, the apparatus configured to mitigate surface occlusion 100 is not limited to the aforementioned configuration and may be configured to include additional elements and/or omit one or more of the aforementioned elements. The apparatus configured to mitigate surface occlusion 100 may be implemented as part of a vehicle 110, as a standalone component, as a hybrid between an on vehicle and off vehicle device, or in another computing device.

The controller 101 controls the overall operation and function of the apparatus configured to mitigate surface occlusion 100. The controller 101 may directly or indirectly control one or more of a power supply 102, a storage 103, an output 104, a sensor 105, a user input 106, a communication device 108 and an occlusion mitigating element 109, of the apparatus configured to mitigate surface occlusion 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the power supply 102, the storage 103, the output 104, the sensor 105, the user input 106, the communication device 108 and the occlusion mitigating element 109 of the apparatus configured to mitigate surface occlusion 100. The information may be sent and received via a bus or network, or may be directly read or written to/from one or more of the power supply 102, the storage 103, the output 104, the sensor 105, the user input 106, the communication device 108 and the occlusion mitigating element 109 of the apparatus configured to mitigate surface occlusion 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the storage 103, the output 104, the sensor 105, the user input 106, the communication device 108 and the occlusion mitigating element 109, of the apparatus configured to mitigate surface occlusion 100. The power supply 102 may include one or more from among a battery, an outlet, a capacitor, a solar energy cell, a generator, a wind energy device, an alternator, etc.

The storage 103 is configured for storing information and retrieving information used by the apparatus configured to mitigate surface occlusion 100. The storage 103 may be controlled by the controller 101 to store and retrieve information received from one or more sensors 105 as well as computer or machine executable instructions to control the occlusion mitigating element 109. The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The storage 103 may store information on a fog condition, an ice condition, a surface temperature of a surface or a lens, a dew point temperature, and an offset temperature. The offset temperature is an offset from the surface temperature of a surface or a lens. In addition, the storage 103 may store a lookup table storing dew point temperatures that correspond to a reference temperature detected by a temperature sensor and humidity information detected by a humidity sensor. The information on the fog condition or the ice condition can include a probability or value corresponding to the risk of fog or the risk of frost or ice. The value may be between zero and one hundred. The storage 103 may also store machine-readable instructions executable to implement the apparatus configured to mitigate surface occlusion 100.

The output 104 outputs information in one or more forms including: visual, audible and/or haptic form. The output 104 may be controlled by the controller 101 to provide outputs to the user of the apparatus configured to mitigate surface occlusion 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, etc. The output 104 may output notification including one or more from among an audible notification, a light notification, and a display notification. The notification may include information notifying of the activation of the occlusion mitigating element 109 or notification of a fog condition or an ice condition on a surface or lens. The output 104 may also display images and information provided by one or more sensors 105.

The sensor 105 may include one or more from among a lidar, a radar, an ultrasonic sensor, a video camera, a still image camera, an antenna, an infrared camera, and any other sensor suitable for perceiving an environment around a vehicle or other machine. The sensor 105 may include a surface exposed to an environment, such as that external to the machine or vehicle. The surface may be susceptible occlusion in the of form frost, ice, or fog.

The user input 106 is configured to provide information and commands to the apparatus configured to mitigate surface occlusion 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. The user input 106 may also be configured to receive a user input to activate or deactivate the occlusion mitigating element 109.

The ambient condition sensor 107 may include a temperature sensor such as a thermometer, a humidity sensor or an ice sensor. The ambient condition sensor 107 may provide information on temperature, humidity and/or ice to the controller 101.

The communication device 108 may be used by apparatus configured to mitigate surface occlusion 100 to communicate with several types of external apparatuses according to various communication methods. The communication device 108 may be used to send/receive various information such as information on operation mode of the vehicle and control information for operating the apparatus configured to mitigate surface occlusion 100 to/from the controller 101. For example, the communication device 108 may send/receive information dew point temperatures, a reference temperature, humidity information, information on a fog condition, information on an ice condition, a surface temperature of a surface or a lens, and/or an offset temperature.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

The occlusion mitigating element 109 may be a heating element such as a heating film disposed on the surface or lens or the sensor 105. The occlusion mitigating element 109 may be powered by the power supply 102 when a fog condition or ice condition is detected by the controller 101, thereby mitigating the condition by heating the surface or lens. According to another example, the occlusion mitigating element 109 may include a plurality of layers of films disposed between two layers of glass and having a PVB layer in between the plurality of layers of films. The plurality of layers of films may include a de-icing film and a defogging film. The layers of film may be connected to a Buss bar configured to power the films with power from a power supply 102. The occlusion mitigating element 109 may be powered by a pulse width modulated signal.

According to an example, the controller 101 of the apparatus is configured to mitigate surface occlusion 100 may be configured to determine whether at least one of a fog condition or an ice condition exists on a surface. The controller 101 is also configured to control the occlusion mitigating element 109 according to the determined at least one of the fog condition and the ice condition, a surface temperature, a dew point temperature, and the offset temperature. The determination of the controller 101 may be based on an offset temperature. In particular, the controller 101 may be configured to determine the dew point temperature from a lookup table stored in a storage device 103 based on a reference temperature detected by a temperature sensor and a humidity detected by a humidity sensor. Moreover, the offset temperature relative to the surface temperature is specified by the control set point that is determined by calibration engineers based on the sensor accuracy and responsiveness of the power supply. Typically, the control set point of the offset temperature varies between 5 degrees to 10 degrees Celsius, but is not limited thereto. The accuracy and the responsiveness of the sensors and the power supply are used to set the control set point. The greater the accuracy and speed of the sensors and the power supply, the smaller the control set point and the offset temperature.

The controller 101 may be configured to power off the occlusion mitigating element if the dew point temperature is less than the offset temperature. The controller 101 may be configured to power on the occlusion mitigating element to a full power state if the surface temperature is less than the dew point temperature. In addition, the controller 101 may be configured to power on the occlusion mitigating element to a power level proportional to the determined at least one of the fog condition and the ice condition if the surface temperature is greater than the dew point temperature and the dew point temperature is greater than the offset temperature.

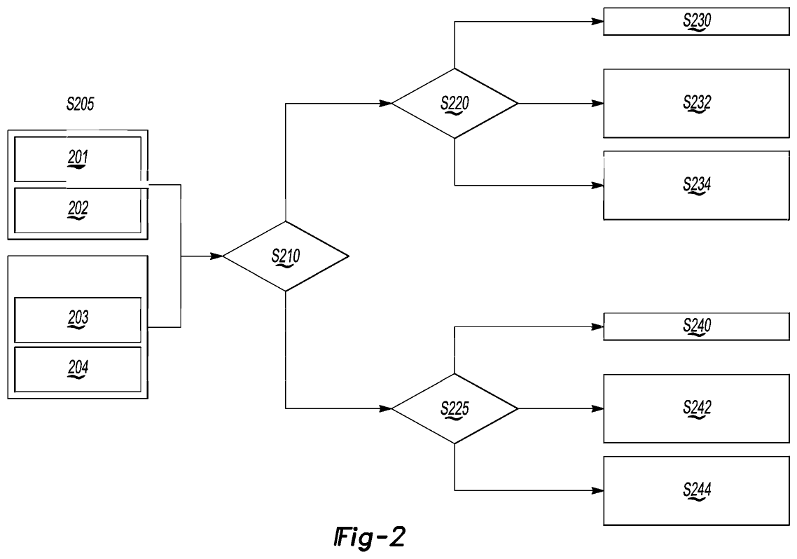

FIG. 2 shows a flow diagram of a method that mitigates surface occlusion according to an exemplary embodiment. The method of FIG. 2 may be performed by the apparatus configured to mitigate surface occlusion 100 or may be encoded into a computer readable medium as instructions that are executable by a computer to perform the method.

Referring to FIG. 2, information on surface temperature (e.g., an optical window temperature), an offset temperature (i.e., a calibrated control set point lower than the optical window temperature corresponding to the accuracy of a temperature sensor and speed of the power supply), and a dew point temperature is received in operation 205. The information on the dew point temperature may be determined from information on air temperature and relative humidity. The information received in operation S205 is used to determine the operating mode in operation S210. For example, if the offset temperature is greater than zero, the method continues to operation SS20 to evaluate the fog risk and if the offset temperature is less than zero, the method continues to operation SS25 to evaluate the frost or ice risk.

In operation S220, the offset temperature is compared to the dew point temperature and the surface temperature. If the offset temperature is greater than the dew point temperature, a low fog potential is determined and the power of the occlusion mitigating element 109 is kept off or switched off in operation S230. If the dew point temperature is greater than the surface temperature, then a high risk of fog is determined and the occlusion mitigating element 109 is set to full power to reduce the fog or mitigate the occlusion in operation S234. If the surface temperature is greater than the dew point temperature and the dew point temperature is greater than the offset temperature, then power to the occlusion mitigating element 109 is set to a level corresponding to the fog risk in operation S232.

In operation S225, the offset temperature is compared to the dew point temperature and the surface temperature. If the offset temperature is greater than the dew point temperature, a low ice potential is determined and the power of the occlusion mitigating element 109 is kept off or switched off in operation S240. If the dew point temperature is greater than the surface temperature, then a high risk of ice is determined and the occlusion mitigating element 109 is set to full power to reduce the ice or mitigate the occlusion in operation S244. If the surface temperature is greater than the dew point temperature and the dew point temperature is greater than the offset temperature, then power to the occlusion mitigating element 109 is set to a level corresponding to the ice risk in operation S242.

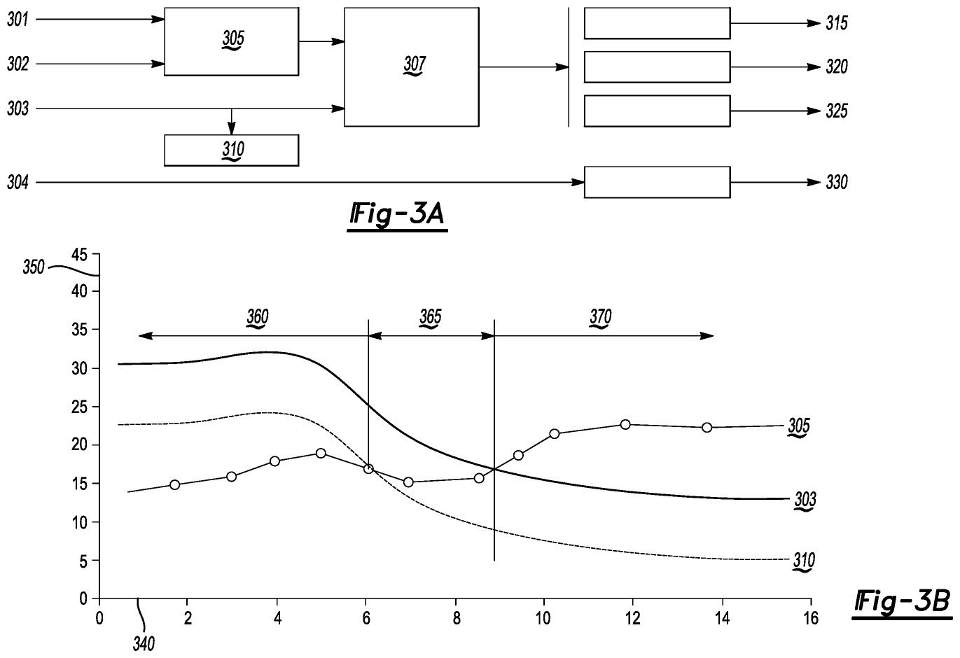

FIGS. 3A and 3B show a flow diagram of a method that determines fog potential and setting power and mode of a de-fogging device according to an aspect of an exemplary embodiment.

Referring to FIG. 3A, a reference temperature 301 from a temperature sensor and a relative humidity 302 from a humidity sensor are input into a dewpoint lookup table 305 to estimate a dewpoint temperature. The dewpoint temperature and surface temperature 303 are then used to compute the fog condition risk value in block 307. The fog condition risk value may be a value between 1 and 100.

A mode may be set according to an offset temperature 310. The mode may be then used to control switch modes between de-icing and de-fogging. In this case, the mode may be a defogging mode of the occlusion mitigating element 109. The fog risk value calculated in block 307 and the mode control may then be used to control power to the occlusion mitigating element 109 to mitigate occlusion caused by fog when the mode is a de-fogging mode. The power of the occlusion mitigating element 109 may be set to off 315 if the fog risk is zero, full power 330 if the fog risk is 100, or a power value 320 between 0-100 corresponding to the fog risk value.

Referring to FIG. 3B, a graph showing the relationship between the fog risk 360, 365, 370, the dew point temperature 305, the surface temperature 303, and the offset temperature 310 is shown. The temperature in degrees Celsius is shown on the y-axis 350 and an elapsed time is on the x-axis 340.

As can be understood from the figure, there is a fog risk of 100% when the dew point temperature 305 is greater than the surface temperature 303 and the offset temperature 310 causing the occlusion mitigating element 109 to be set to full power. Further, there is little or no risk of fog when the surface temperature 303 is greater than the offset temperature 310 and the dew point temperature 305. Further still, there is a range of fog risk when the dew point temperature 305 is greater than the offset temperature 310, but less than the surface temperature 303. This range is used to control the power to the occlusion mitigating element 109 according to fog risk bands 460, 465, and 470.

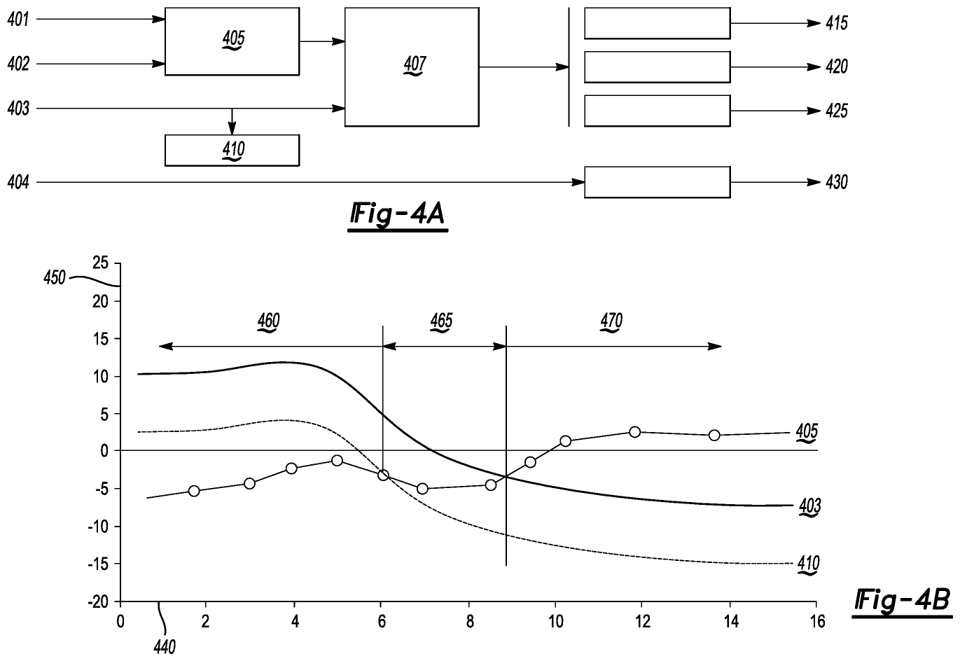

FIGS. 4A and 4B show a flow diagram of a method that determines frost and ice potential and setting power and mode of a de-icing device according to an aspect of an exemplary embodiment.

Referring to FIG. 4A, a reference temperature 401 from a temperature sensor and a relative humidity 402 from a humidity sensor are input into a dewpoint lookup table 405 to estimate a dewpoint temperature. The dewpoint temperature and surface temperature 403 are then used to compute the frost or ice risk value in block 407. The frost/ice risk value may be a value between 1 and 100.

A mode may be set according to an offset temperature 410. The mode may be then used to control switch modes between de-icing and de-fogging. In this case, the mode may be a defrost mode of the occlusion mitigating element 109. The frost/ice risk value calculated in block 407 and the mode control may then be used to control power to the occlusion mitigating element 109 to mitigate occlusion caused by frost/ice when the mode is a de-icing mode. The power of the occlusion mitigating element 109 may be set to off 415 if the frost/ice risk is zero, full power 430 if the frost/ice risk is 100, or a power value 420 between 0-100 corresponding to the frost/ice risk value.

Referring to FIG. 4B, a graph showing the relationship between the frost/ice risk 460, 465, 470, the dew point temperature 405, the surface temperature 403, and the offset temperature 410 is shown. The temperature in degrees Celsius is shown on the y-axis 450 and an elapsed time is on the x-axis 440.

As can be understood from the figure, there is a frost/ice risk of 100% when the dew point temperature 405 is greater than the surface temperature 403 and the offset temperature 410 causing the occlusion mitigating element 109 to be set to full power. Further, there is little or no risk of fog when the surface temperature 403 is greater than the offset temperature 410 and the dew point temperature 405. Further still, there is a range of fog risk when the dew point temperature 405 is greater than the offset temperature 410, but less than the surface temperature 403. This range is used to control the power to the occlusion mitigating element 109 corresponding to the frost/ice risk bands 460, 465, 470,

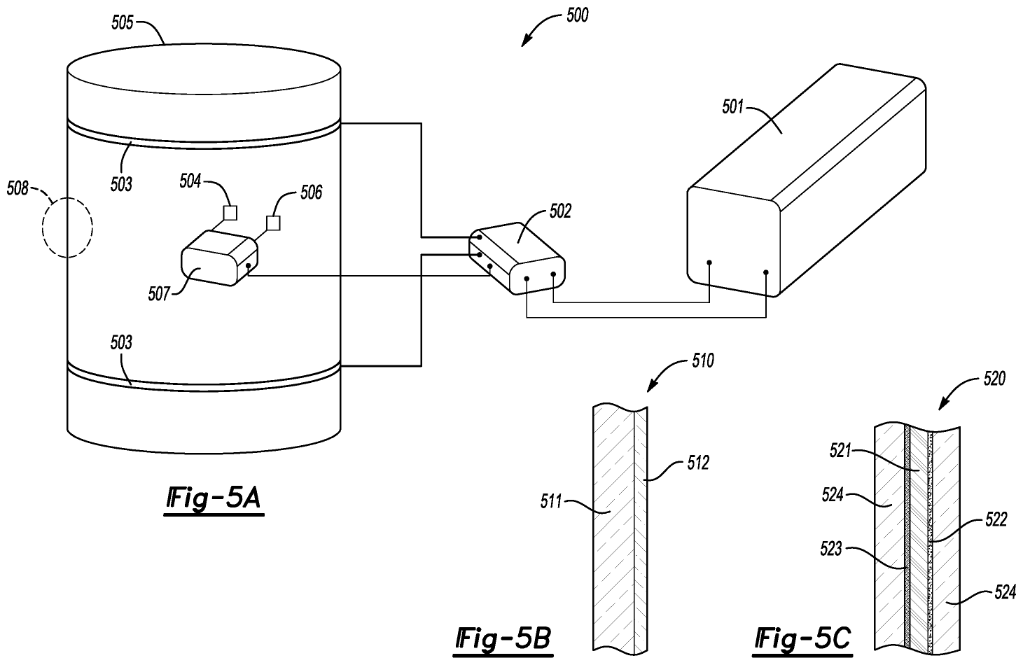

FIGS. 5A-5C show illustrations of various aspects of an apparatus that mitigates surface occlusion according to several aspects of exemplary embodiments.

Referring to FIG. 5A, an illustration of the overall setup of the apparatus that mitigates surface occlusion 500 is shown. In this example, a battery back 501 is connected to a switch 502 that is controlled by a controller 507. The controller 507 receives inputs from a temperature sensor 504, a humidity sensor 506 or an ice sensor (not shown) and uses the information provided by the sensors to control the power switch 502 to activate the apparatus that mitigates surface occlusion when appropriate. The power switch 502 controls the flow of power from the battery pack 501 to the Buss bar 503. The Buss bar 503 receives the power and powers the surface 508 or optical window when power switch 502 is active, thereby mitigating the fog or ice on the optical window or surface 508.

Referring to FIG. 5B, an illustration of one example of optical window 508 or surface configuration 510 is shown. The surface configuration 510 includes a plastic optical window 511 with a heating film 512 layer. The heating film 512 layer may be disposed directly on the plastic optical window 511. The plastic optical window 511 may be made of other materials such as glass, etc.

Referring to FIG. 5C, an illustration of a second example of optical window 508 or surface configuration 520 is shown. The surface configuration 520 includes two outer glass layers 524. Sandwiched in between the glass layers is a de-icing film 523 that is activated during an ice or frost risk condition and a defogging film 522, that is activated during a fog condition. A PVB layer 521 is disposed in between the de-icing film 523 and the defogging film 522.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. An apparatus configured to mitigate surface occlusion, the apparatus comprising:
a surface;
an occlusion mitigating element integrated with the surface; and
a controller configured to determine at least one of a fog condition or an ice condition based on an offset temperature from a surface temperature, and control the occlusion mitigating element according to the determined at least one of the fog condition and the ice condition, the surface temperature of the surface, a dew point temperature, and the offset temperature.

2. The apparatus of claim 1, wherein the controller is configured to determine the dew point temperature from a lookup table based on a reference temperature detected by a temperature sensor and a humidity detected by a humidity sensor.

3. The apparatus of claim 1, wherein the controller is configured to set the offset temperature according to a control setpoint corresponding to an accuracy of a temperature sensor measuring the surface temperature and a speed of a power supply.

4. The apparatus of claim 3, wherein the controller is configured to determine the fog condition if the offset temperature is greater than zero.

5. The apparatus of claim 4, wherein the controller is configured to determine the ice condition if the offset temperature is less than zero.

6. The apparatus of claim 5, wherein the controller is configured to power off the occlusion mitigating element if the dew point temperature is less than the offset temperature.

7. The apparatus of claim 6, wherein the controller is configured to power on the occlusion mitigating element to a full power state if the surface temperature is less than the dew point temperature.

8. The apparatus of claim 7, wherein the controller configured to power on the occlusion mitigating element to a power level proportional to the determined at least one of the fog condition and the ice condition if the surface temperature is greater than the dew point temperature and the dew point temperature is greater than the offset temperature.

9. The apparatus of claim 8, wherein the controller is configured to control to output a pulse width modulated signal according to the power level.

10. The apparatus of claim 1, wherein the surface comprises the lens of a sensor.

11. The apparatus of claim 10, wherein the sensor comprises at least one from among a lidar and a camera.

12. The apparatus of claim 11, wherein the occlusion mitigating element comprises a heating film disposed on the lens.

13. The apparatus of claim 12, further comprising a power supply and a power switch configured to supply power to the occlusion mitigating element.

14. The apparatus of claim 13, wherein the controller is configured to control the power supplied from the power supply to the occlusion mitigating element based on the determined at least one of the fog condition and the ice condition, the lens temperature, the dew point temperature, and the offset temperature.

15. The apparatus of claim 10, wherein the occlusion mitigating element comprises a de-icing film and a defogging film with a polyvinyl butyral (PVB) layer disposed between the de-icing film and the defogging film, and
wherein the occlusion mitigating element is disposed on the lens between glass layers of the lens.

16. The apparatus of claim 1, wherein the occlusion mitigating element comprises a buss bar, wherein the controller is configured to supply power to the buss bar to mitigate the surface occlusion based on the determined at least one of the fog condition and the ice condition, the surface temperature, the dew point temperature, and the offset temperature.

17. A method of mitigating surface occlusion, the method comprising
determining at least one of a fog condition or an ice condition based on an offset temperature from a surface temperature; and
in response to determining the at least one the fog condition or the ice condition is in effect, controlling an occlusion mitigating element according to the determined at least one of the fog condition and the ice condition, the surface temperature of the surface, a dew point temperature, and the offset temperature.

18. The method of claim 17, wherein the offset temperature is determined based on a sensor accuracy of a sensor measuring the surface temperature and responsiveness of a power supply.

19. The method of claim 18, wherein the controlling the occlusion mitigating element comprises controlling to power on the occlusion mitigating element to a full power state if the surface temperature is less than the dew point temperature and controlling to power off the occlusion mitigating element if the dew point temperature is less than the offset temperature.

20. The method of claim 18, wherein the controlling the occlusion mitigating element comprises controlling to power on the occlusion mitigating element to a power level proportional to the determined at least one of the fog condition and the ice condition if the surface temperature is greater than the dew point temperature and the dew point temperature is greater than the offset temperature.
